(19) United States
(12) Patent Application Publication
(10) Pub. No.: US 2024/0349759 A1
(43) Pub. Date: Oct. 24, 2024

(54) DEVICE, METHOD AND SYSTEM FOR PURIFICATION OF FOOD PRODUCTS

(71) Applicant: Yerramsetty Bhojraj Rohit Naidu, Hyderabad (IN)

(72) Inventor: Yerramsetty Bhojraj Rohit Naidu, Hyderabad (IN)

(21) Appl. No.: 18/138,143

(22) Filed: Apr. 24, 2023

(51) Int. Cl. A23L 3/28; A23L 3/3445

(52) U.S. Cl. CPC A23L 3/28; A23L 3/3445

(57) ABSTRACT

The present invention generally relates to the field of Purification Device, method and system. More particularly, this invention relates to purification of raw food produce using Advanced Oxidation Process & Photolysis that performs on Nanotechnology. The invention reduces the impact of harmful pesticides, insecticides, germs, pathogens, virus, harmful anti-oxidants, heavy metals, etc., while keeping the inherent properties intact.

### CROSS REFERENCE TO RELATED APPLICATIONS

This patent application claims the benefit of PCT/1N2029/05683 filed Sep. 18, 2019. This application is a divisional of U.S. patent application Ser. No. 17/276,888 filed Mar. 17, 2021.

Both of the above application are incorporated by reference herein.

### FIELD OF THE INVENTION

The present invention generally relates to the field of Purification Device, Method and System. More particularly, this invention relates to purification of food using Advanced Oxidation Process & Photolysis, performing on Nanotechnology.

### BACKGROUND OF THE INVENTION

Disinfection with ultraviolet (UV) light and dramatically increase the storage and shelf life of food produce. Extending shelf life by a safe and relatively inexpensive process allows the manufacturers of these products to reduce the use of chemical preservatives and disinfectants. UV light disinfection system is very effective compared with conventional chemical additives and cleaning agents. UV light disinfection systems are utilized in many industries as an environmentally safe and regulation free method of sterilization. Additionally, UV disinfection systems are free from consumer or environmental concerns that are often voiced regarding conventional chemical disinfection methods. UV disinfection systems have been used successfully in many drinking and process water applications, and in hospitals, pharmaceutical and beverage production. It is also cost effective and economical.

Bacteria, molds and viruses substantially absorb UV wavelengths of 210 nm and 310 nm. It is understood that this absorbed UV radiation adversely affects the survivability of many pathogens, such as bacteria, molds and viruses. Standard, commercially available UV lamps can efficiently emit a broad germicidal spectrum that includes these specific wavelengths of UV light, and in the intensity required for effective control. A UV dose of approximately 0.1 joules/cm² is considered affective in controlling these pathogens. Disinfection is a term that is typically employed to describe the elimination of substantially all pathogens with very few survivors, while the term sterilization is employed to describe the total elimination of all pathogens, without any survivors.

UV light has also been utilized to disinfect the surfaces of packages. A wrapped or enveloped product is subjected to a UV light source to control potential contamination on the surface of the packaging. Conventional packaging lines equipped with surface UV disinfection equipment often include a photoelectric interlock. The photoelectric interlock includes a photoelectric sensor that detects the presence of a package or cart on in proximity to the UV lamp on a process line. The UV lamp is mounted to a fixed frame, typically above the process line. When enabled by the photo electric interlock, the UV lamp illuminates the package as it passes beneath and so sterilizes the top facing surfaces of the package.

A problem occurs when the package has surfaces that require disinfection but these surfaces do not face the UV lamp as the package passes the UV lamp. Additional passes under the UV lamp must be made to illuminate the other surfaces of the package. This single surface disinfection may be acceptable for flat, roughly two sided packaging, but is typically not acceptable for multi-sided packages.

An additional problem occurs if it is desired to sterilize containers of various sizes. In practice, the process line is configured to handle only one size of a container. The process line must be shut down and reconfigured to compensate for any change in distance from the UV lamp to the carton.

Produce products, such as fruits, vegetables, meat, are washed and typically scrubbed before packing into boxes. Typically, clean, sterilized or at least substantially disinfected water must be utilized to wash the produce product to minimize the introduction of molds and bacteria onto the produce product. Ultraviolet light treatment of the wash water is employed to provide assurance that the wash water is pure and clean.

Additionally, when brushes are used to scrub, dry or polish the produce product, the brushes themselves can become contaminated with molds or bacteria and serve to spread the contamination to much of the produce that passes through the brushes. This problem makes storing the packed fruit difficult, because a single contaminated piece of produce product can ruin an entire box of packed produce in a short period.

Ozone gas (O3) is a very strong oxidizing agent, having an oxidation potential more than twice that of chlorine and approximately three times that of hydrogen peroxide. Ozone also has the advantage of breaking down upon use as an oxidant in to oxygen (O2), which is normally beneficial. Thus, ozone currently finds widespread usage as an oxidizing agent for bacterial, virus, and mold control for vegetable, meat and fish storage.

Accordingly, existing methods, devices and systems are often difficult to use and to properly purify food products, and often present users with in consistent methods that often prevent the users from making effective use of the technology.

Therefore, there is a genuine need to overcome all the above problems by developing an improved device, method and system that addresses the herein above-mentioned issues and problems with purifying food products. There is further a need for a device, method and system, which is efficient, dynamic and simple.

### OBJECTIVE OF THE INVENTION

It is an object of the present invention to provide a device, system and method for purification of food products.

It is an object of the present invention to provide a device, system and method for cleansing raw food produce at a Nano level, while maintaining its nutritional values, texture and flavor.

Its is an object of the present invention to provide a device, system and method for Innovative embedded software the carry out the whole method.

It is an object of the present Invention To provide a device System and method for reducing the impact of harmful pesticides, Insecticides, germs, pathogens, virus, harmful antioxidants, antibiotics, toxins, heavy metals, etc., While keeping the inherent properties intact.

It is an object of the present invention to provide a device, system and method, which is efficient, dynamic and simple.

### SUMMARY OF THE INVENTION

The present invention generally relates to the field of Purification Device, method and system. More particularly, this invention relates to purification of food using Advanced Oxidation Process & Photolysis that performs on Nanotechnology.

Although the present disclosure is explained with respect to one or more food disinfection device, method and system, it would be appreciated that this application is used for illustration purposes, but it is not a limitation.

The present invention provides a food disinfection device, method and system. The invention includes Advanced Oxidation Process (AOP), Photolysis and performs at a Nano level. The component used in the method comprises Water, ultraviolet light and Ozone. Ultra violet light source provides a disinfecting illumination of a food product. The device can be utilized to receive the food product and move the food product into proximity of the ultraviolet light source, ozone and water.

In another embodiment of the present invention, the device, method and system cleanses raw food produce at Nano level, while maintaining its nutritional values, texture and flavor. The device, method and system can be implemented but is not limited to one or more electronic devices, to facilitate user interaction with a device, and to help the user more effectively engage with local and/or remote services.

In another embodiment of the present invention, the device, method and system are a natural purifier, which makes every bite of food you eat tastier & healthier. It brings out the aroma of the food produce.

In another embodiment of the present invention, the device, method and system reduce the impact of harmful pesticides, insecticides, germs, pathogens, anti-oxidants, etc., while keeping the inherent properties intact.

In another embodiment of the present invention, the device, method and system comprise a method to exhibit a unique way for a complex opto-hydro ionization process. This is a synergistic reaction—a complex irradiation process between Ultraviolet, water and Ozone along with certain specific HF currents in aqua medium. This is the first of its kind method making it the most advanced in its category.

In another embodiment of the present invention, the device, method and system catalyze a cellular level Chlorophyll reaction which rebuilds the Oxygen content in various foods and especially in all leafy vegetables. This means, the food materials become oxygen rich. This saves you from unnecessary intake of artificial anti-oxidants which may do harm in long term.

In another embodiment of the present invention, the device, method and system comprise a unique cleansing process which reduces impurities and increases the shelf life of food products by 2 to 3 times.

In another embodiment of the present invention, the device comprises but is not limited to one or more ionizer for generating Ozone using dry air; one or more switch for device on/off purpose; one or more Ultraviolet light source to generate ultraviolet rays; one or more air pump for supplying oxygen to Ionizer; one or more sound source; one or more LED light for indication; one more timer; one or more Water in-let valve for supplying the water inside the device; one or more Water out-let for draining the water from the device; one or more Chokes to give power supply to Ultraviolet light source; one or more Keypad To give commands for operation of the device; one or more display to display the commands on one or more screen; one or more doors Door for closing and opening purpose of the device; one or more Grids for protection of one or more Quartz glass jacket; one or more Tray to keep Raw materials; one or more Ozone release holes for Ozone gas to release from one or more ozonator through ozone holes; one or more legs to mount the whole device.

In another embodiment of the present invention, the method comprises of starting the device; automatically locking the door; reading the inputs; working as per the input; Ionizer; ultraviolet light source and Airpump to work as per their requirement; the process to continue as per predetermined thresholds; light and sound indications to be generated when the method is over.

In another embodiment of the present invention, the method comprises food product into proximity of an ultraviolet light source. The ultraviolet light source illuminates the exterior surface of the food product. The product can be rotated to illuminate substantially the entire exterior surface of the food product.

In another embodiment of the present invention, the food product is disinfected by direct exposure to ultraviolet light, ozone and water. Conventional disinfecting methods for produce products, such as fruits and vegetables consisted of washing the produce products with either sterilized or disinfected water, rather than direct ultra violet disinfection.

In another embodiment of the present invention, the food products of various sizes can be adequately disinfected without stopping and re-configuring the process line.

In another embodiment of the present invention, advanced Oxidation Technologies (AOT) has been used laser triggered and driven AOT platform are disclosed, including a method for the advanced oxidation of dangerous chemical and biological sources suspected in particular regions of food products.

In another embodiment of the present invention, the method comprises innovative embedded software to carry out the whole method.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The other objects, features and advantages will occur to those skilled in the art from the following description of the preferred embodiment and the accompanying drawings in which:

FIG. 1 is a block diagram illustrating a device for purification of food products for use with various embodiments of the invention;

FIG. 2 is a block diagram illustrating a internal view of the device for purification of food products for use with various embodiments of the invention;

FIG. 3 is a Flow diagram illustrating the method for purification of food products for use with various embodiments of the invention.

Although specific features of the present invention are shown in some drawings and not in others, this is done for convenience only as each feature may be combined with any or all of the other features in accordance with the present invention.

### DETAILED DESCRIPTION OF THE DRAWINGS

Embodiments herein and the various features and advantageous details thereof are explained more fully with reference to the non-limiting embodiments that are illustrated in the accompanying figures and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the following description, numerous specific details are set forth in order to provide a thorough understanding of embodiments of the present invention. It will be apparent to one skilled in the art that embodiments of the present invention may be practiced without some of these specific details.

Embodiments of the present invention may include various steps, which will be described below. Steps may be performed by hardware components or may be embodied in device-executable instructions, which may be used to cause a general-purpose or special-purpose with the instructions to perform the steps. Alternatively, steps may be performed by a combination of hardware, software, and/or by human operators.

If the specification states a component or feature “may”, “can”, “could”, or “might” be included or have a characteristic, that particular component or feature is not required to be included or have the characteristic.

The present invention generally relates to the field of Purification Device, method and system. More particularly, this invention relates to purification of food using Advanced Oxidation Process & Photolysis and performs at a Nanotechnology level.

Although the present disclosure is explained with respect to one or more food disinfection device, method and system, it would be appreciated that this application is used for illustration purposes, but it is not a limitation.

The present invention provides a food disinfection device, method and system. The invention includes Advanced Oxidation Process (AOP), Photolysis and performs at a Nano level. The component used in the method comprises Water, ultraviolet light and Ozone. Ultraviolet light source provides a disinfecting illumination of a food product. The device can be utilized to receive the food product and move the food product into proximity of the ultraviolet light source, ozone and water.

According to the present invention, the present invention provides a food disinfection device, method and system. The invention includes Advanced Oxidation Process (AOP), Photolysis and performs at a Nano level. The component used in the method comprises Water, ultraviolet light and Ozone. Ultra violet light source provides a disinfecting illumination of a food product. The device can be utilized to receive the food product and move the food product into proximity of the ultraviolet light source, ozone and water.

According to the present invention, the device, method and system cleanses raw food produce at a Nano level, while maintaining its nutritional values, texture and flavor. The device, method and system can be implemented but is not limited to one or more electronic devices, to facilitate user interaction with a device, and to help the user more effectively engage with local and/or remote services.

According to the present invention, the device, method and system is a natural purifier, which makes every bite of food you eat tastier & healthier. It brings out the aroma of the food produce.

According to the present invention, the device, method and system reduces the impact of harmful pesticides, insecticides, germs, pathogens, anti-oxidants, etc., while keeping the inherent properties intact.

According to the present invention, the device, method and system comprises a method to exhibit a unique way for a complex opto-hydroionization process. This is a synergistic reaction—a complex irradiation process between Ultraviolet, water and Ozone along with certain specific HF currents in aqua medium. This is the first of its kind method making it the most advanced in its category.

According to the present invention, the device, method and system catalyzes a cellular level Chlorophyll reaction which rebuilds the Oxygen content in various food and especially in all leafy vegetables. This means, the food materials become oxygen rich. This saves you from unnecessary intake of artificial anti-oxidants which may do harm in long term.

According to the present invention, the device, method and system comprise a unique cleansing process which reduces impurities and increases the shelf life of food products by 2 to 3 times.

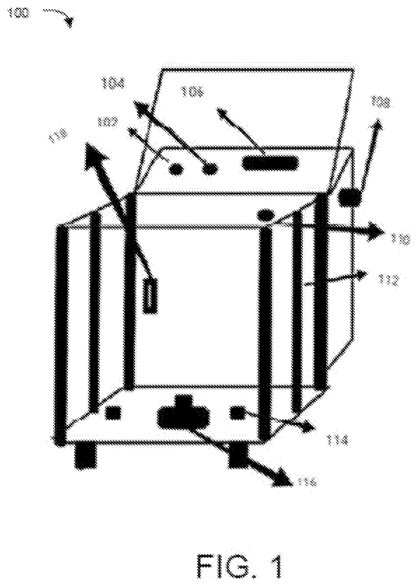

FIG. 1 is a block diagram illustrating a device for purification of food products for use with various embodiments of the invention. According to the FIG. 1, the device 100 comprises of a first button 102, a second button 104, a display unit 106, a water inlet 108, a proximity sensor 110, one or more ultra violet lamps 112, one or more ozone pumping holes 114, one or more water drain outlets 116, one or more sensors 118 and a storage compartment 120 for storing (not shown in figure). The parts of the device 100 are described herein above in detail and hence not described again to avoid repetition.

According to the present invention, the device 100 comprises a first button 102 for purification of but not limited to vegetables, fruits, pulses and spices.

According to the present invention, the device 100 comprises a second button 104 for purification of but not limited to Meat and Eggs.

According to the present invention, the device 100 comprises a display unit 106 for displaying but not limited to displaying processing time for one or more time frames. For instance, vegetables may require 25 minutes for purification and Non-vegetables may require 30 minutes for purification. An error message will also be displayed if any problem arises with the device.

According to the present invention, the device 100 comprises a water inlet unit 108 for one or more water inlet. For instance, if anyone presses a water inlet button, water comes through the inlet valve.

According to the present invention, the device 100 comprises one or more sensor 110 for but not limited to proximity sensor; temperature Sensor; Accelerometer; IR Sensor (Infrared Sensor); Pressure Sensor; Light Sensor; Ultrasonic Sensor; Touch Sensor; Color Sensor; Humidity Sensor; Tilt Sensor; Flow and Level Sensor; Smoke, Gas and Alcohol Sensor. For instance, if anyone opens the door, the process will be switched off automatically, and simultaneously when anyone closes the door, the process will continue.

According to the present invention, the device 100 comprises one or more Ultraviolet Lamps 112 for generating Ultraviolet Rays. For instance, the Ultraviolet rays Length Range may be but not limited from 212 to 1554 mm, and Wattage Range from 6 to 65 w.

According to the present invention, the device 100 comprises one or more Ozone pumping holes 114 for pumping ozone inside the device.

According to the present invention, the device 100 comprises a water drain outlet unit 116 for one or more water outlet. For instance, when the process is completed, the internal water will drain out through the water drain outlet unit.

According to the present invention, the device 100 comprises a sensor 118 for but not limited to identifying water levels. When someone presses the water button, water comes through the inlet valve up to the sensor and it will automatically close the water inlet.

According to the present invention, the device 100 comprises Light Emitting Diode (LED) Lights to indicate the working condition for one or more components such as but not limited to Ionizer, UV and Air pump.

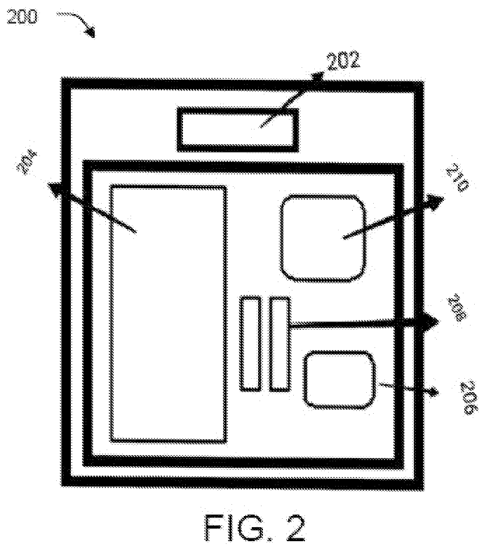

FIG. 2 is a block diagram illustrating a internal view of the device for purification of food products for use with various embodiments of the invention. According to the FIG. 2, the device 200 comprises of a Printed Circuit Board 202 which controls one or more functions and operation; an Ozonator 204 which generates ozone (O3); an airpump 206 for supplying oxygen (O2) to the ozonator; one or more chokes 208 for converting Direct current (DC) to Alternating current (AC) for Ultraviolet Lamps; and one or more Solenoid Valve 210 for controlling the flow or direction of air or liquid in fluid power systems. The parts of the device 200 are described herein above in detail and hence not described again to avoid repetition.

According to the present invention, the device 200 comprises a Solenoid valve 210 which is an electrically activated valve. It is used to control the flow or direction of air or liquid in fluid power systems. It can also controls water pressure.

According to the present invention, the Printed Circuit Board (202) is connected to First button (102); the Printed Circuit Board (202) is connected to second button (104); the Printed Circuit Board (202) is connected to display unit (106); the Printed Circuit Board (202) is connected to water inlet (108); the Printed Circuit Board (202) is connected to the proximity sensor (110); the Printed Circuit Board (202) is connected to UV lamps (112); the Printed Circuit Board (202) is connected to ozone pumping holes (114); the Printed Circuit Board (202) is connected to water drain outlet (116); the Printed Circuit Board (202) is connected to water level sensor (118); the Printed Circuit Board (202) is connected to ozonator (204); the Printed Circuit Board (202) is connected to Air pump (206); the Printed Circuit Board (202) is connected to chokes (208); the Printed Circuit Board (202) is connected to solenoid valve (210); the Ozonator (204) outlet pipe is connected too zone pumping holes (114) and the Air pump (206) is connected to ozone inlet (204) for the operations.

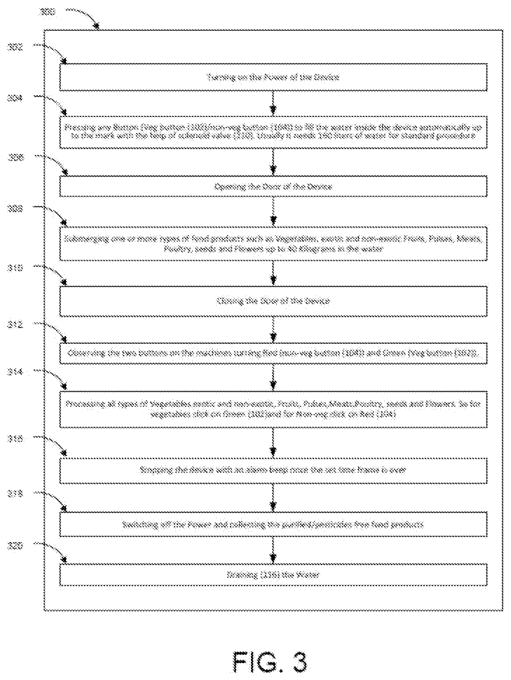

FIG. 3 is a Flow diagram illustrating the work flow for purification of food products wherein the steps comprising as follows: 300 shows the Purification of food products workflow; at 302 Turning on the Power of the Device; at 304 Pressing any Button (Veg button (102)/non-veg button (104)) to fill the water inside the device automatically up to the mark with the help of solenoid valve (210), Usually it needs 160 liters of water for standard procedure; at 306 Opening the Door of the Device; at 308 Submerging one or more types of food products such as Vegetables, exotic and non-exotic Fruits, Pulses, Meats, Poultry, seeds and Flowers up to 40 Kilograms in the water; at 310 Closing the Door of the Device; at 312 Observing the two buttons on the devices turning Red (non-veg button (104)) and Green (Veg button (102)); at 314 Processing all types of Vegetables exotic and non-exotic, Fruits, Pulses, Meats, Poultry, seeds and Flowers. So for vegetables click on Green (102) and for Non-veg click on Red (104); at 316 Stopping the device with an alarm beep once the set time frame is over; at 318 Switching off the Power and collecting the purified/pesticides free food products; and at 320 Draining (116) the Water.

According to the present invention, the device comprises but is not limited to one or more ionizer for generating Ozone using dry air; one or more switch for device on/off purpose; one or more Ultraviolet light source to generate ultraviolet rays; one or more air pump for supplying oxygen to Ionizer; one or more sound source; one or more LED light for indication; one more timer; one or more Water in-let valve for supplying the water inside the device; one or more Water outlet for draining the water from the device; one or more sockets to give power supply to Ultraviolet light source; one or more Keypad To give commands for operation of the device; one or more display to display the commands on one or more screen; one or more doors Door for closing and opening purpose of the device; one or more Grids for protection of one or more Quartz glass jacket; one or more Tray to keep Raw materials; one or more Ozone release holes for Ozone gas to release from one or more ozone at or through ozone holes; one or more legs to mount the whole device.

According to the present invention, the method comprises of starting the device; automatically locking the door; reading the inputs; working as per the input; Ionizer, ultraviolet light source and Air pump to work as per their requirement; the process to continue as per predetermined thresholds; light and sound indications to be generated when the method is over.

According to the present invention, the method comprises food product into proximity of an ultraviolet light source. The ultraviolet light source illuminates the exterior surface of the food product. The product can be rotated to illuminate substantially the entire exterior surface of the food product.

According to the present invention, the food product is disinfected by direct exposure to ultraviolet light, ozone and water. Conventional disinfecting methods for produce products, such as fruits and vegetables consisted of washing the produce products with either sterilized or disinfected water, rather than direct ultra violet disinfection.

According to the present invention, the food products of various sizes can be adequately disinfected without stopping and re-configuring the process line.

According to the present invention, Advanced Oxidation Technologies (AOT) has been used laser triggered and driven AOT platform are disclosed, including a method for the advanced oxidation of dangerous chemical and biological sources suspected in particular regions of food products.

According to the present invention, the method comprises innovative embedded software to carry out the whole method.

The foregoing illustrated and described embodiments of the invention are susceptible to various modifications and alternative forms, and it should be understood that the invention generally, as well as the specific embodiments described herein, are not limited to the particular forms or embodiments disclosed, but cover all modifications, equivalents and alternatives falling within the scope of the appended claims. By way of non-limiting example, it will be appreciated by those skilled in the art that particular features or characteristics in one embodiment may be combined as suitable with features or characteristics described in another embodiment. Moreover, the device and method for of the present invention can be a system used along with an automated or even with a manual system.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

### Advantages of the Invention

The present invention provides a system and method for device, system and method for purification of raw food produce.

The present invention provides a system and method for cleansing raw food produce at a Nano level, while maintaining its nutritional values, texture and flavor. The present invention provides a system and method for an improved artificial intelligence system.

The present invention provides a system and method for innovative embedded software to carry out the whole method.

The present invention provides a system and method for reducing the impact of harmful pesticides, insecticides, germs, pathogens, virus, harmful anti-oxidants, heavy metals, etc., while keeping the inherent properties intact. The present invention provides a system and method for an improved data processing and analyzing system.

It is an object of the present invention to provide a device, system and method, which is efficient, dynamic and simple.

We claim:

1. A food purification device comprising:
a circuit board for controlling functions and operation; a storage compartment for storing; one or more sound source; one or more timer; one or more keypad to give commands for operation of the device; one or more grids for protection of one or more quartz glass jacket; one or more tray to keep raw materials; a door for opening and closing the device; a first button; a second button; a display unit for displaying; a water inlet unit for entry of water;
one or more proximity sensor for sensing the proximity; one or more ultra violet lamps for radiating ultraviolet an ozonator for generating ozone; one or more lights for showing the indication; one or more ozone pumping holes for pumping ozone; one or more water drain outlets for draining the water; one or more sensors for sensing water levels; an air pump for supplying oxygen to the ozonator;
one or more chokes 208 for converting direct current to alternating current for the ultraviolet lamps; and one or more solenoid valve for controlling the flow or direction of air or liquid and for purifying the food products.

2. The food purification device of claim 1, wherein the first button is for purification of vegetables, fruits, grains, pulses and spices.

3. The food purification device of claim 1, wherein the second button is for purification of meat and eggs.

4. A system of food purification comprising:
a circuit board for controlling functions and operation; a storage compartment for storing; one or more sound source; one or more timer; one or more keypad to give commands for operation of the device; one or more grids for protection of one or more quartz glass jacket; one or more tray to keep raw materials; a door for opening and closing the device; a first button; a second button; a display unit for displaying; a water inlet unit for entry of water;
one or more proximity sensor for sensing the proximity; one or more ultra violet lamps for radiating ultraviolet rays; an ozonator for generating ozone; one or more lights for showing the indication; one or more ozone pumping holes for pumping ozone; one or more water drain outlets for draining the water; one or more sensors for sensing water levels; an air pump for supplying oxygen to the ozonator;
one or more chokes 208 for converting direct current to alternating current for the ultraviolet lamps; and one or more solenoid valve for controlling the flow or direction of air or liquid and for purifying the food products.

5. The food purification system of claim 4, wherein the first button is for purification of vegetables, fruits, grains, pulses and spices.

6. The food purification system of claim 4, wherein the second button is for purification of meat and. eggs.
